(19) United States
(12) Patent Application Publication
(10) Pub. No.: US 2018/0062831 A1
(43) Pub. Date: Mar. 1, 2018

(54) Massively Scalable Blockchain Ledger

(71) Applicant: Jiangang Zhang, San Jose (CA)

(72) Inventor: Jiangang Zhang, San Jose (CA)

(21) Appl. No.: 15/669,586

(22) Filed: Aug. 4, 2017

Related U.S. Application Data
(60) Provisional application No. 62/381,950, filed on Aug. 31, 2016.

(51) Int. Cl. H04L 9/06

(52) U.S. Cl. CPC H04L 9/0637; H04L 9/0643

(57) ABSTRACT

A massively scalable blockchain ledger without scalability issue on each blockchain node and the blockchain ledger itself by partitioning the full value range of the cryptographic hash of the blockchain blocks into a configurable but large number of block buckets and auto-assign and auto-adjust these buckets roughly evenly amongst reliable blockchain mining nodes.

### CROSS REFERENCE TO RELATED APPLICATION

This application claims priority from U.S. Patent Application Ser. No. 62/381,950, filed Aug. 31, 2016 and entitled “Massively scalable blockchain ledger” the disclosure of which is hereby incorporated entirely herein by reference.

### FIELD OF THE INVENTION

The present invention is in the technical field of blockchain stack. More particularly, the present invention is in the technical field of achieving massively scalable blockchain ledger.

### BACKGROUND OF THE INVENTION

Conventional blockchain stacks, e.g. bitcoin, Ethereum, HyperLedger etc., all require the full ledger be stored on each and every blockchain mining nodes (also known as full nodes), which is not only unnecessary, but also posts scalability issues on blockchain adoption

### SUMMARY OF THE INVENTION

The present invention is an optimization to the blockchain to achieve massively scalable blockchain ledger.

The present invention discovers the fact that there's no need for all blockchain nodes to store all the blockchain blocks, so long as the blocks not locally stored can be reliably retrieved with confidence on its immutability.

The present invention, partitions the full value range of the cryptographic hash of the blockchain blocks into a configurable but large number of block buckets(denoted as bb) and auto-assign and auto-adjust these buckets roughly evenly amongst reliable blockchain mining nodes. On joining the blockchain, a new node expresses its willingness to host the ledger, i.e. as a ledger node, which is marked by all current nodes on the blockchain. When a node is unreachable, detected via missing of heartbeat messages or activities, all current nodes also marks this unreachability.

Periodically, each node evaluates its peers' activities and decides the reliable set of ledger nodes locally preferred. The auto-elected and auto-adjusted master node proposes ledge nodes and multicasts that proposal to all other nodes, which evaluates the proposal against its observation, decides whether to endorse or not (or even propose another one or trigger master re-election if the proposal is too far off, e.g. more than ⅓ of nodes should not be in the proposal).

When collected endorsement from ⅔ of the current reliable nodes, the acting master node sends the decided ledger nodes list with endorsement proof. On receiving the decision, each node verifies the decision and rebalances its block hosting if necessary.

Periodically, each ledger nodes randomly selects a block bucket it hosts and multicasts all blocks in it to all other nodes to prove its possession of all blocks in the block bucket.

Whenever a node requires a remote block, i.e. a block it does not host or has in its cache, it would figure out the current nodes hosting it based on the ledger scaling strategy, then contact the corresponding node(s) directly for data of that block.

With a balancing and redundancy factor, denoted as rf, at least rf nodes must be assigned to host a given block bucket; as part of the scaling strategy, the rf nodes are auto-chosen and auto-adjusted to be preferably geographical distributed with redundancy in each location.

### BRIEF DESCRIPTION OF THE DRAWING

FIG. 1 is the sequence diagram on the periodic (re)balance of the blockchain ledger with block 100 representing a new node, block 110 representing any current ledge node and block 120 containing the periodic (re)balancing flow.

FIG. 2 is the sequence diagram on periodic proof of a ledge node to show all other nodes its possession of all blocks of a random block bucket it hosts, where block 200 is any ledger node and block 210 is any other ledge node and block 220 is the periodic flow on proof of hosting all blocks of a block bucket.

FIG. 3 is the sequence diagram for a node to retrieve a block remotely, where block 300 is the requesting node and block 310 is the hosting node.

### DETAILED DESCRIPTION OF THE INVENTION

### The Problem Statement

The block chain's main property is immutability of (past) transactions. To achieve that, a transaction is signed by the sender and transactions are continuously mined (grouped and signed) as blocks (by blockchain miners a.k.a. blockchain verification nodes) with each block refers to the cryptographic hash of the block immediately before it. This way, alteration of any transaction, requires alteration of the block enclosing it and all blocks after that, and update all blockchain nodes that have a copy of the block chain where node ownership is distributed amongst trustless parties. This makes successful alteration of a transaction highly unlikely, hence the immutability property.

All current block chain implementations, assumes that all blockchain verification nodes have to have all data of all blocks in the chain. As the blockchain grows over time, the ledger becomes gigantically larger and longer over time which causes storage scalability issue on each blockchain node and the blockchain as a whole.

As a matter of fact, as long as each block is reliably stored somewhere and retrievable any time it's needed, there's no need to have each blockchain node to store all data of all blocks in the ledger. This fact inspires the present invention.

### Ledger Scaling Strategy

The present invention, partitions the full value range of the cryptographic hash of the blockchain blocks into a configurable large number of block buckets (denoted as bb) and auto-assign and auto-adjust these buckets roughly evenly amongst reliable blockchain mining nodes, called ledger nodes in the present invention.

Only reliable nodes are considered for hosting of block buckets. Node reliability is automatically observed and adjusted based on node activity on the blockchain, its heart beat messages (if present) and its capabilities and capacities as expressed on node startup& update (details later in the present invention specification).

For reliability, the present invention introduces redundancy factor, denoted as rf, so that all data of all blocks in each block bucket are stored fully on at least rf nodes.

For geographical availability, geographical load balancing and reduced overall latency on block retrieval, the rf nodes for a given block bucket is automatically geographically distributed if possible. Geo-location and location proximity is auto-detected via IP address lookup, network delay measurement or explicit configuration.

Significant change to the current list of ledger nodes, e.g. ⅓ more nodes joined or left, or if a block bucket fails to have rf nodes hosting it, automatically triggers a rebalance (details later in the present invention specification).

This does not prevent any node from hosting all data of all blocks in the chain. Actually a node can explicitly claim without necessarily being considered in the rf nodes of a given block bucket. One example is an authorized escrow ledger node that is high capacity on storage and bandwidth volunteering or providing a paid service to host the full ledger.

### Initial Node Startup

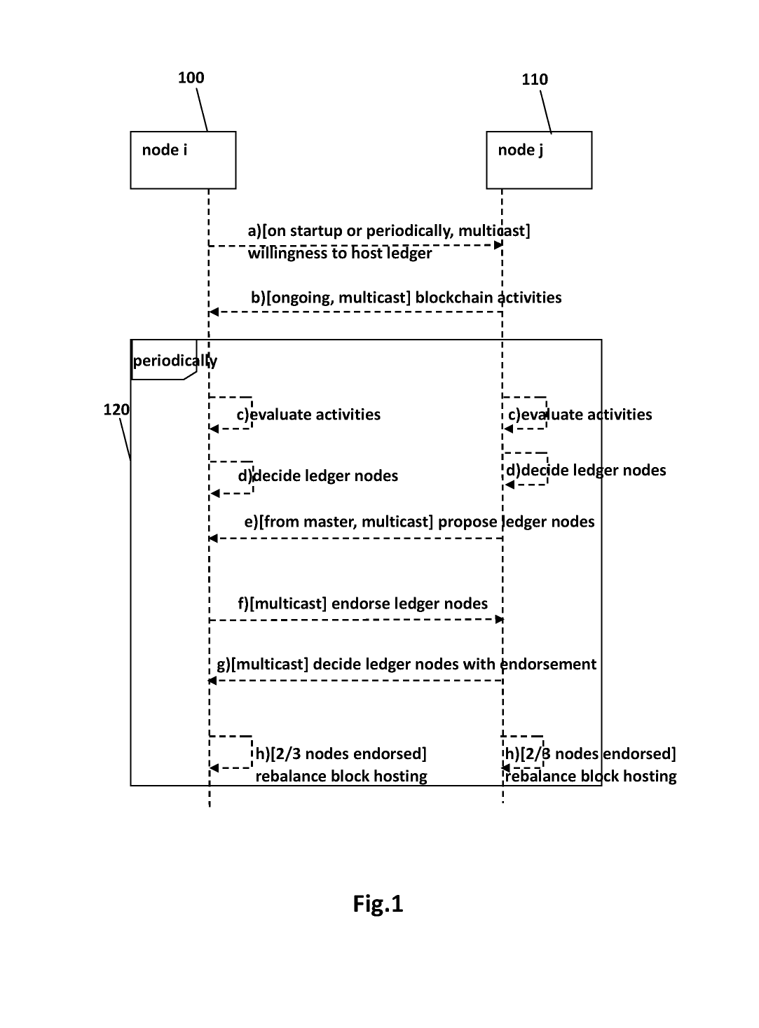

As shown in step a) of FIG. 1, on node startup (or periodically), a node expresses its willingness to host the ledger by multicast a willingness message, LEDGERN_VOLUN message to all nodes of the block chain. The self-signed LEDGERN_VOLUN message, includes its storage/CPU/RAM/bandwidth capacity, IP address, its entry point for ledger read/write access, intention for the full ledger or part of it, intention to be counted as part of the rf nodes on automatic scaling balance etc. A node can be an escrow for the full ledger providing service free of charge or with a fee.

Upon receiving the LEDGERN_VOLUN message, each blockchain node saves this info for automatic scaling decision making later.

### Balancing and Rebalancing

As shown in block 120 in FIG. 1, each blockchain node periodically evaluates peers' activities (step c), and decides locally the set of ledger nodes (step d) based on node reliability, capability/capacity etc. The peers' activities include but not limited to heartbeat messages, transactions received from or going through each node, as well as blocks generated by each node, etc. These activities help evaluate the node reliability. Node capability/capacity includes CPU info, RAM (Random Access Memory), storage and bandwidth etc.

If the node is the master of the blockchain, and if the new locally preferred set of ledger nodes is significantly different than the current one, e.g. ⅓ of nodes are different, or there're block buckets not covered by rf nodes for redundancy, a new full or partial set of ledger nodes are multicast to all nodes in the blockchain via self-signed LEDGERN_PROPOSE message (step e). The LEDGERN_PROPOSE message includes, for each block bucket or block bucket group, the rf nodes (its entry points, public key etc.) that are responsible for hosting all data of these blocks, the incremental update type (add, remove, full), the cryptographic hash of a previous LEDGERN_PROPOSE message that this message is in response of as a counter-proposal if applicable, timestamp, salt, its public key, etc.

Upon receiving the LEDGERN_PROPOSE each blockchain node verifies its signature, compares the proposal against its own preference based on its local observation. If there's less than ⅓ (configurable) nodes difference, it would multicasts a self-signed LEDGERN_ENDORSE message (step f) to all other nodes. Otherwise, it would multicasts its self-signed LEDGERN_PROPOSE message (not shown in FIG. 1) as counter-proposal. The LEDGERN_ENDORSE message includes the cryptographic hash of the LEDGERN_PROPOSE message the node endorses, timestamp, salt, and its public key, etc.

If the master successfully collects endorsements from at least ⅔ of nodes, it multicasts a self-signed LEDGERN_LIST message to all blockchain nodes. The LEDGERN_LIST message includes what's in the LEDGERN_PROPOSE message and list of endorsements from all nodes (or the cryptographic hash of each endorsement). If not (within a configurable timeout period), it multicasts a self-signed LEDGERN_IGNORE message to all blockchain nodes (not shown in FIG. 1). The LEDGERN_IGNORE message includes the cryptographic hash of the LEDGERN_PROPOSE message, timestamp, salt, its public key, etc. The master election mechanism should observe for the LEDGERN_LIST or LEDGERN_IGNORE message and the lack of either within a given timeout period and trigger master re-election if received a LEDGERN_IGNORE message or if timed out without receiving either LEDGERN_LIST or LEDGERN_IGNORE message.

If ⅔ of all blockchain nodes endorses the new list of ledger nodes as listed in the LEDGERN_LIST, all nodes will auto-balance its hosting of blocks based on the block buckets that it's responsible for (shown as step h) in FIG. 1). For blocks that it is responsible for hosting but have not stored yet, it would retrieve it from the nodes hosting them. For blocks that it is no longer responsible for hosting them, it may decide to purge them from its local storage or when needed.

Note that the present invention does not mandate the master election mechanism, other than what mentioned above and it assumes that the master is auto-elected and auto-adjusted fairly and can recover from a malicious or unresponsive master etc. These are normal master election requirements not worth elaborating in detail in the present invention specification.

### Periodic Proof of Hosting

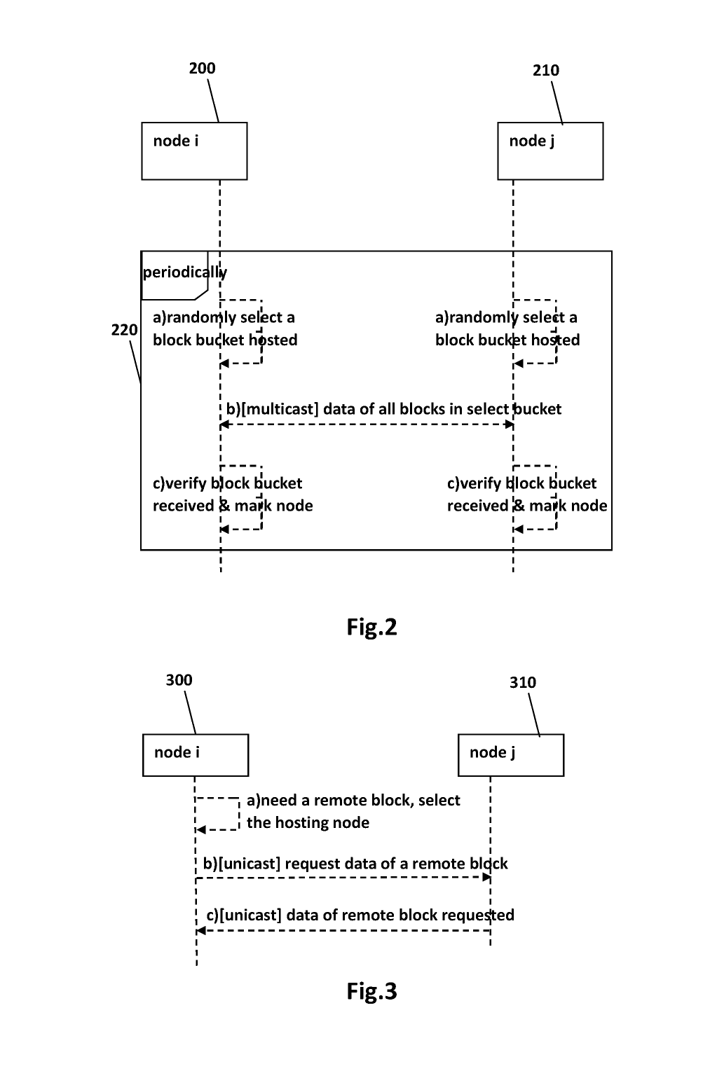

As shown in block 220 of FIG. 2, periodically, each ledger node (represented by block 200) randomly selects one block bucket that it's responsible for hosting (shown as step a), multicasts a self-signed LEDGERN_BLOCK message to all other ledger nodes (represented by block 210) to show proof of storage. The LEDGERN_BLOCK message includes the block(s) in the randomly selected block bucket, timestamp, salt and its public key, etc.

Upon receiving LEDGERN_BLOCK message, each node updates the block bucket hosting status locally. If status of a block bucket is not updated by at least rf nodes responsible for hosting it, the master ledger node is responsible for initiating a (re-)balancing as shown in block 120 of FIG. 1. If a master fails to initiate this re-balance, master re-election must be triggered.

### Remote Block Retrieval

As shown in FIG. 3, when any node (shown as block 300) is in need of a block not locally available, identified by its cryptographic hash, it would figure out the block bucket for it and find out nodes hosting the block (as shown in step a) by consulting the current ledger scaling strategy.

Then it sends a unicast message LEDGERN_BREQ to request a block (step b in FIG. 3). The LEDGERN_BREQ message includes the cryptographic hash of the block to request and maybe other info.

Upon receiving the LEDGERN_BREQ message, the hosting node (shown as block 310) returns LEDGERN_BRES message to the requesting node (shown as block 300). The LEDGERN_BRES message includes response status (found, not-found, not-owner), reason and the block data if found.

1. A massively scalable blockchain ledger is an optimization to the blockchain to achieve massively scalable blockchain ledger by partitioning the full value range of the cryptographic hash of the blockchain blocks into a configurable but large number of block buckets and auto-assign and auto-adjust these buckets roughly evenly amongst reliable blockchain mining nodes;
wherein on joining the blockchain, a new node expresses its willingness to host the ledger and when a node is unreachable, detected via missing of heartbeat messages or activities, all current nodes marks this unreachability.

2. A massively scalable blockchain ledger according to claim 1, wherein each node evaluates its peers' activities and decides the reliable set of ledger nodes locally preferred. Furthermore, the auto-elected and auto-adjusted master node proposes ledge nodes and multicasts that proposal to all other nodes, which evaluates the proposal against its observation, decides whether to endorse or not.

3. A massively scalable blockchain ledger according to claim 1, wherein when collected endorsement from ⅔ of the current reliable nodes, the acting master node sends the decided ledge nodes list with endorsement proof. On receiving the decision, each node verifies the decision and rebalances its block hosting if necessary.

4. A massively scalable blockchain ledger according to claim 1, wherein each ledger nodes randomly selects a block bucket it hosts and multicasts all blocks in it to all other nodes to prove its possession of all blocks in the block bucket.

5. A massively scalable blockchain ledger according to claim 1, whenever a node requires a remote block, it would figure out the current nodes hosting it based on the ledger scaling strategy, then contact the corresponding node(s) directly for data of that block.

6. A massively scalable blockchain ledger according to claim 1, wherein rf (balancing and redundancy factor) nodes are assigned to host a given block bucket and as part of the scaling strategy, they are auto-chosen and auto-adjusted to be preferably geographical distributed with redundancy in each location.
